(19) United States
(12) Patent Application Publication
(10) Pub. No.: US 2005/0020274 A1
(43) Pub. Date: Jan. 27, 2005

(54) Kid trac

(76) Inventor: Ernest Anthony Ursini, Fairfield, CT (US)

Correspondence Address: ERNEST URSINI, 76 LOVERS LANE, FAIRFIELD, CT, 06430, US

(21) Appl. No.: 10/211,878

(22) Filed: Oct. 7, 2002

(51) Int. Cl. H04Q 7/20

(52) U.S. Cl. 455/456.1

(57) ABSTRACT

This child locating device is compact and portable. It has a multitude of stealth, placement, and deployment applications. It can be disguised on a child's wrist, as a bracelet, pendant, watch, ankle bracelet, pocket item, attatched to clothing, worn in hair, or in or on a shoe. The device is activated via internet and/or dialing software. The GPS software then tracks from many locations. Locations include home, office, car, or on foot. The system deploys and tracks from a variety of devices, laptop computer, personal computer, or a hand held computer. It combines hardware, GPS software, telephone line, cellular, and internet into a complete child locator. Its combination of versatility and portability makes it a one of a kind child tracking system.

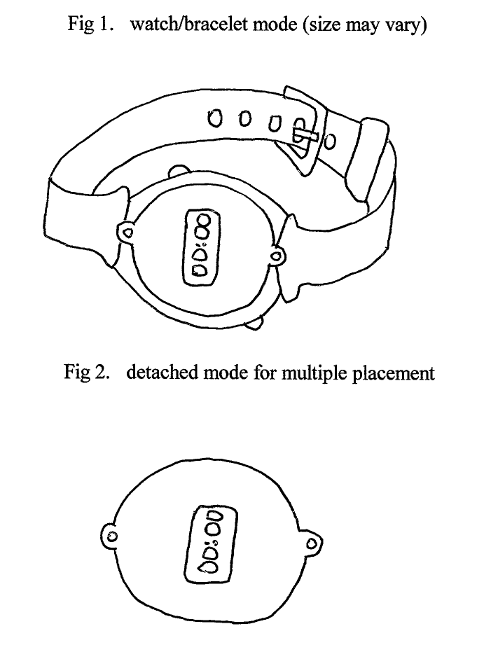

(Kid Trac): A child locating device and software that when activated connects to the internet via a dialing program.

The device then sends a cellular based global positioning system location back to a desk top computer, laptop and/or hand held system. The software will then track the child's location from car, home and/or office while in contact with federal, state and/or local police. The device can be place anywhere on the child and disguised. The device is rechargeable and can last days on one charge. Each device owner will be registered with federal, state and/or local police.

1. What I claim as my invention is a compact, portable child locating device that uses hardware, software, cellular, GPS, and phone line technologies to find a lost child. The battery operated device, once activated, sends a cellular GPS location to a home computer, laptop, or hand held device. The GPS software then tracks a child's location from many locations while on the phone with local, state, or federal police. The device is placed anywhere on the child's body.
